(19) United States
(12) Patent Application Publication
(10) Pub. No.: US 2004/0129496 A1
(43) Pub. Date: Jul. 8, 2004

(54) Step attachment

(76) Inventor: Dale Clark, Hesperia, CA (US)

Correspondence Address: Karl M. Steins, Steins & Associates, Suite 120, 2333 Camino del Rio South, San Diego, CA, 92108, US

(21) Appl. No.: 10/337,805

(22) Filed: Jan. 7, 2003

(51) Int. Cl. E06C 9/00

(52) U.S. Cl. 182/92

(57) ABSTRACT

A Step Attachment is disclosed. Also disclosed is a device that is strong enough to be used in the construction profession. The outside dimensions of the attachment are extremely compact, such that the device can be easily carried in conventional tool boxes and on tool belts. The attachment further provides additional slip-resistance for secure footing under a variety of conditions and use patterns. The device is further manufactured from standard stock components and is assembled extremely easily.

### BACKGROUND OF THE INVENTION

1. Field of the Invention

This invention relates generally to tools for use in the building construction industry and, more specifically, to a Step Attachment.

2. Description of Related Art

There are a variety of temporary steps, scaffolds and other structures that have evolved over time in the construction industry. Of particular note is Harsh, U.S. Pat. No. 3,561,563 for a “Portable Post Step.” The Harsh device is intended to provide a worker with the ability to turn a sign post into a ladder (so that the worker can work on the sign structure). While the Harsh device may have been suitable for its intended purpose, it is not suitable for use as a step for the construction industry: (1) because the thin sheet metal design provides insufficient rigidity to accommodate the weight of a worker and his or her tools; (2) the flat surface provided by the Harsh step is too easily soiled, after which it may provide a slip hazard to the worker's footing; and (3) the overall profile and dimensions of the Harsh device are too large to conveniently fit into a worker's tool belt and/or tool box.

Another prior device is the Koffski “Portable Step;” U.S. Pat. No. 4,754,841. The Koffski device seeks to accomplish a similar task as Harsh, but with a different structure. While the Koffski step is likely to be more rigid and durable than the Harsh device, it too has its problems. First, the Koffski device is formed with a totally enclosed “U shaped body” for encompassing a post—because the post is totally encompassed when the step is attached, it mandates that step be either slipped over the top of the post, or under the bottom; as such, it cannot be used on an existing “stud wall.” Furthermore, the Koffski device is anything but sleek and condensed; as with Harsh, this device is unwieldy for storing and use with conventional tools, belts and totes. Also, Koffski has a relatively flat tread for standing upon—like Harsh, this may be susceptible to becoming slippery.

Yet another temporary step design is provided by Field, U.S. Pat. No. 4,696,372. The Field “Portable Step and Carrying Device for Stud Walls” solves some of the problems of the Harsh and Koffski devices, but still leaves room for improvement. The Field device includes a spring-loaded member having a “stud-engaging end” for pinching a wood stud to prevent the step from sliding down a stud on which it is installed. Although the Field device departs from the wide, flat tread surface, it still fails to provide a truly fail-safe design to prevent it from becoming slippery when soiled. Furthermore, the Field device seeks to reduce its size by addition of the spring-loaded stud-engaging end; a byproduct of this choice is moving parts that will surely reduce the overall reliability of the device. In fact, it would seem to be a generally unsafe design choice to rely on a single spring to hold the device in place on the wooden stud.

What is needed, therefore, is a step attachment for temporary use in wood-framed structures that has improved slip resistance for footing, a small overall package size, as well as the strength and durability necessary to last in the grueling use patterns of the construction industry.

### SUMMARY OF THE INVENTION

In light of the aforementioned problems associated with the prior devices, it is an object of the present invention to provide a Step Attachment that is strong enough to be used in the construction profession. The attachment should have as small outside dimensions as possible, such that the device can be easily carried in conventional tool boxes and on tool belts. The attachment should further provide additional slip-resistance for secure footing under a variety of conditions and use patterns. It is a further object that the device be manufacturable from standard stock components and be assembled extremely easily.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a perspective view of a preferred embodiment of the step attachment of the present invention;

FIG. 2 is a top view of the attachment of FIG. 1;

FIG. 3 is a front view of the attachment of FIGS. 1 and 2;

FIG. 4 is a side view of the attachment of FIGS. 1-3;

FIG. 5 is a partial cutaway side view of the rung member of the attachment of FIGS. 1-4; and

FIG. 6 is a perspective view of the attachment of FIGS. 1-5.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Step Attachment.

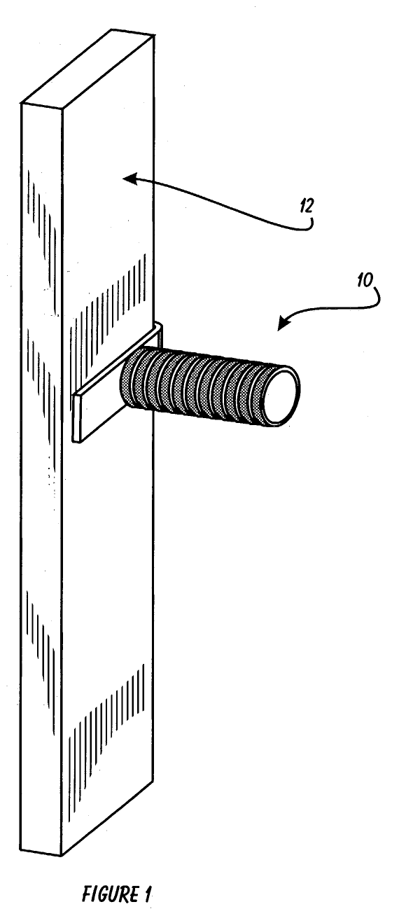

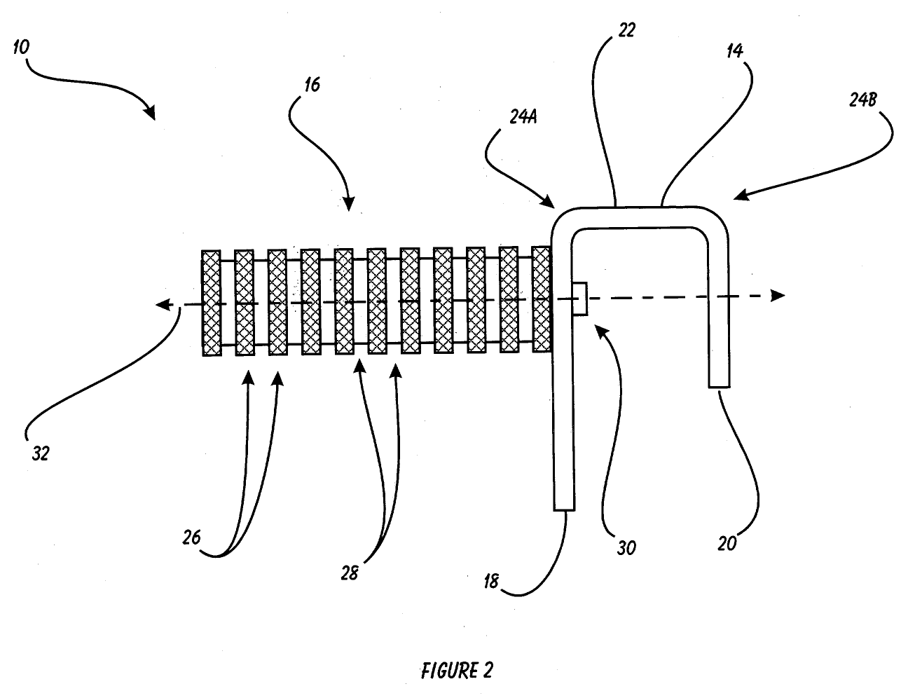

The present invention can best be understood by initial consideration of FIG. 1. FIG. 1 is a perspective view of a preferred embodiment of the step attachment 10 of the present invention. As with the prior art previously discussed, the attachment 10 of the present invention is design to attach to, and extend from a piece of dimensional lumber 12, an example of which is a “stud.” Unlike some of the prior devices, however, the attachment 10 of the present invention can be simply slipped over the side of the stud 12, without the need for slipping it onto one end of the board or the other. Also, the height position of the attachment 10 along the board 12 is infinitely adjustable by simply lifting up on the attachment 10 and then sliding it either up or down, as desired. In order to understand additional detail regarding the invention, we shall now turn to FIG. 2.

FIG. 2 is a top view of the attachment 10 of FIG. 1. The attachment comprises two main components: the rung member 16 and the bracket member 14. The bracket 14 is a U-shaped element having a first leg 18 and a second leg 20 in generally parallel aligment. The bracket is preferably manufactured from a flat piece of steel that is bent into the U-shape shown. The bent bracket 14 can thereafter be hardened if desired in order to provide a secure and durable tool. This design lends itself to rapid and low-cost manufacturing.

The first and second legs 18 and 20 are attached to one another by a connecting leg 22. In this embodiment, there are curved portions 24A and 24B at the point of intersection between the legs 18 and 20 and the connecting leg 22. These curved portions 24 are provided for two reasons—to simplify the manufacturing process (i.e. by forming the bracket 14 by bending). Second, the curved portions act as an anti-jam mechanism to prevent the bracket 14 from getting jammed against the wood stud after prolonged use and/or after substantial weight has been supported by the attachment 10, thereby increasing the safety of the unit.

It should also be readily apparent that the first leg 18 is somewhat longer in length than the second leg 20. The extra length serves to provide additional stability, while the shorter length of the second leg 20 makes the attachment 10 easier to attach and detach from a wood stud.

The Rung member 16 is an elongate cylinder in shape, and is defined by a plurality of ridges 26 along its length, each separated from those adjacent by circumferential grooves therebetween. The ridges 26 provide extremely favorable grip stability for footwear, while the grooves 28 contribute additional grip by providing an area for debris to be scraped off of one's feet prior to and during use.

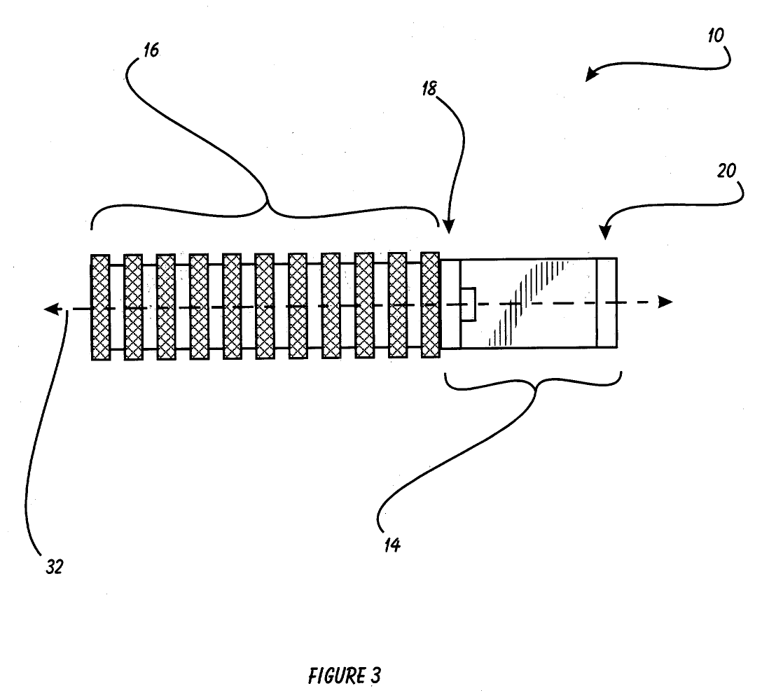

As will be discussed more fully below, it is pointed out that the rung member 16 defines a rung axis 32 at the geometric center of its cross-section. Although not visible from this top view, it is a feature of this embodiment that the attachment 10 be substantially symetrical above and below the axis 32. This will be more clearly depicted below in the front view of FIG. 3.

This embodiment 10 is made from a combination of steel and aluminum parts; specifically, the rung member 16 is preferably machined from a solid piece of aluminum bar stock. The bracket member 14 is bent from a piece of flat steel stock, and the nipple 30 is preferably a piece of threaded steel for interconnecting the rung 16 and the bracket 14, as well as possibly to interact with the stud (not shown). In other embodiments and/or for other applications, other materials may be used. Now turning to FIG. 3, we can further explore the features of the present invention.

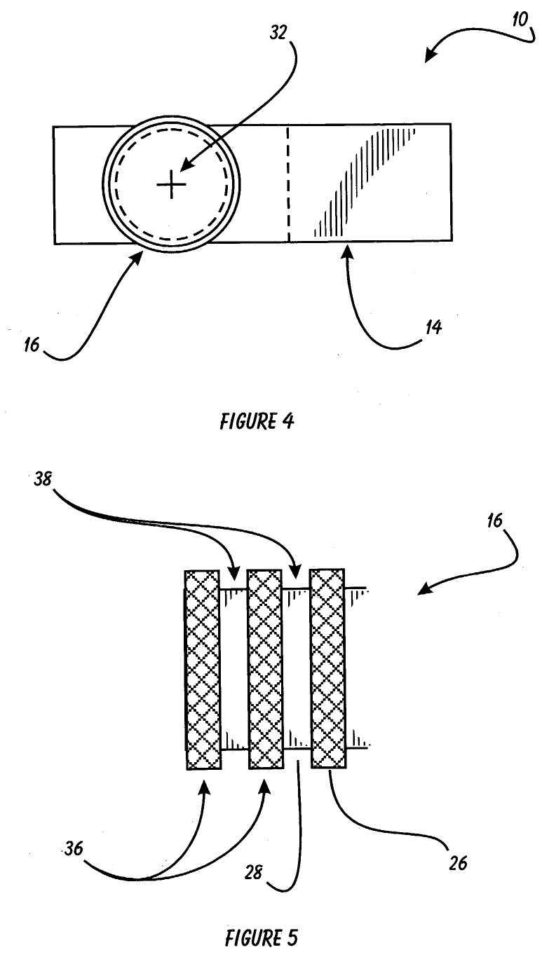

FIG. 3 is a front view of the attachment 10 of FIGS. 1 and 2. As shown here, the first leg 18 and second leg 20 are facing the reader. In this front view (and in a back view also), it can be seen that the step attachment 10 is symmetrical around the plane that is parallel to the rung axis 32. Simply stated, the step attachment is flat in this orientation. This design feature is important because it results in the attachment being extremely compact as compared to any of the prior devices. Because this attachment 10 is very flat, it is easily stored in a toolbox and carried around a job site. Furthermore, and as depicted previously in FIG. 2, the small overall size and shape of the attachment further adds to the packability of the device. As will be clear from FIG. 4, the cross-section of the rung member 16 is circular, providing a consistent profile around its entire circumference for the user to step and stand upon.

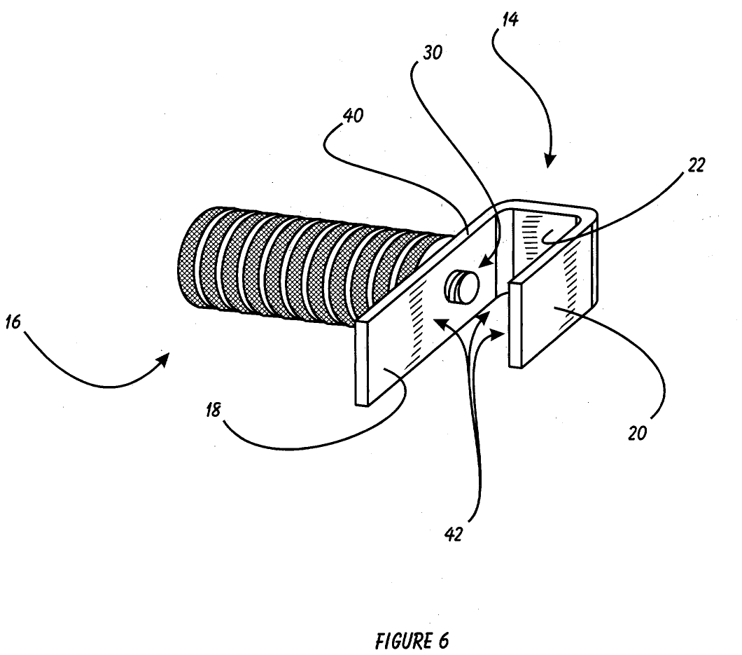

FIG. 4 is a side view of the attachment 10 of FIGS. 1-3. In this view, the rung axis 32 is projecting straight out of the page. It shows that the profile of the rung member 16 is substantially circular. This circular profile means that the ridges and grooves (see FIG. 1 or FIG. 5) are continuously presented all the way around the rung 16, not only on a single (usually the top) surface. Furthermore, the attachment 10 can be installed from the right or the left side, such that either “top” side can be stepped upon. FIG. 5 provides additional detail regarding the rung member 16.

FIG. 5 is a partial cutaway side view of the rung member 16 of the attachment of FIGS. 1-4. As shown in this embodiment, the ridges 26 have a roughened, knurled surface; this provides an abrasive surface for secure footing. In contrast, the grooves 28 have a smooth surface 38 that easily captures debris and then allows it to drop away from the user's footwear. In this embodiment, a diamond-shaped pattern is provided, although other patterns may be used as well. We will now turn to FIG. 6 to take one final look at this novel device.

FIG. 6 is a perspective view of the attachment 10 of FIGS. 1-5. As should be apparent, when installed, the nipple 30 will likely protrude into the surface of the wood stud to which it is attached. This protrusion aids in preventing the device 10 from slipping down the stud. In this embodiment, the nipple 30 is a threaded steel stem; the threads being in engagement with a threaded bore in the rung member 16 and a threaded aperture formed in the bracket member 14. This design provides substantial ease in assembly; the rung 16, nipple 30 and bracket 14 need simply be manufactured separately and then assembled by screwing them into one another.

The configuration of the legs 18 and 20, the separation provided by the connecting leg 22, and the height of the legs 18, 20 and 22 all cooperate such that the bracket 14 cantilevers off of the stud and pinches the stud between the legs 18 and 20 to also prevent the attachment from slipping down the stud.

As discussed above, it should be even clearer here that the top surface 40 of the bracket 14 could also be oriented such that it is facing down when installed on the stud. In either orientation, the rung 16 will provide the same surface upon which the user can stand. For the purpose of later reference, the inner surface 42 of the bracket member 14 is depicted here as well. It is this inner surface 42 that is in contact with the stud when the attachment is installed thereon.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A step attachment for lumber boards, comprising:
a bracket member for engaging a lumber board; and
a rung member extending from said bracket member, said rung member defined by a rung axis and having a substantially circular cross-section.

2. The attachment of claim 1, wherein said rung member is further defined by at least two circumferenctial ridges protruding therefrom, each said ridge separated from another said ridge by a circumferential groove.

3. The attachment of claim 2, wherein said ridges are defined by an outer surface, said outer surface comprising an abrasive texture.

4. The attachment of claim 3, wherein each said groove is defined by an outer surface, said groove outer surface being smoother than said ridge outer surface.

5. The attachment of claim 4, wherein said bracket member is generally U-shaped.

6. The attachment of claim 5, wherein said bracket member comprises a first leg, a second leg and a connecting leg interconnecting said first and second leg.

7. The attachment of claim 6, wherein said first and said second legs each define lengths, said length of said first leg being longer than said length of said second leg.

8. The attachment of claim 7 wherein said bracket further comprises curved portions between said first leg and said connecting leg and said second leg and said connecting leg.

9. The attachment of claim 8, wherein said rung member extends from said first leg.

10. The attachment of claim 9, wherein said first, second and connecting legs define a flat inner surface, said inner surface defining a plane that is perpendicular to said rung member axis.

11. The attachment of claim 10, further comprising a rigid nipple extending from said inner surface of said first leg.

12. A portable step, comprising:
a bracket member for engaging a lumber board, said bracket being generally U-shaped; and
a rung member extending from said bracket member, said rung member defined by a rung axis and having a substantially circular cross-section.

13. The step of claim 12, wherein said bracket member comprises a first leg, a second leg and a connecting leg interconnecting said first and second leg.

14. The step of claim 13, wherein said first, second and connecting legs define a flat inner surface, said inner surface defining a plane that is perpendicular to said rung member-axis.

15. The step of claim 14, further comprising a rigid nipple extending from said inner surface of said first leg.

16. The step of claim 15, wherein said first and said second legs each define lengths, said length of said first leg being longer than said length of said second leg.

17. The step of claim 16, wherein said rung member is further defined by at least two circumferenctial ridges protruding therefrom, each said ridge separated from another said ridge by a circumferential groove.

18. The step of claim 17, wherein said ridges are defined by an outer surface, said outer surface comprising an abrasive texture.

19. The step of claim 18, wherein each said groove is defined by an outer surface, said groove outer surface being smoother than said ridge outer surface.

20. The step of claim 19 wherein said bracket further comprises curved portions between said first leg and said connecting leg and said second leg and said connecting leg.
